(19) United States
(12) Patent Application Publication
(10) Pub. No.: US 2024/0031076 A1
(43) Pub. Date: Jan. 25, 2024

(54) METHOD, DEVICE AND COMPUTER PROGRAM PRODUCT FOR WIRELESS COMMUNICATION

(71) Applicant: ZTE CORPORATION, Shenzhen (CN)

(72) Inventors: Wei CAO, Shenzhen (CN); Nan ZHANG, Shenzhen (CN); Fangyu CUI, Shenzhen (CN)

(73) Assignee: ZTE CORPORATION, Shenzhen (CN)

(21) Appl. No.: 18/361,029

(22) Filed: Jul. 28, 2023

Related U.S. Application Data
(63) Continuation of application No. PCT/CN2021/085065, filed on Apr. 1, 2021.

(51) Int. Cl. H04L 1/1822; H04W 72/11

(52) U.S. Cl. CPC H04L 1/1822; H04W 72/11

(57) ABSTRACT

Method, device and computer program product for wireless communication are provided. A method includes: receiving, by a wireless communication terminal from a wireless communication node, a Semi-Persistent Scheduling, SPS, activation; receiving, by the wireless communication terminal from the wireless communication node, an SPS downlink transmission corresponding to the SPS activation; and transmitting, by the wireless communication terminal to the wireless communication node, acknowledge information in response to a part of hybrid automatic repeat request, HARQ, processes for the SPS downlink transmission.

This application is a continuation of PCT/CN2021/085065, filed Apr. 1, 2021, the content of which is incorporated herein by reference in its entirety.

### TECHNICAL FIELD

This document is directed generally to wireless communications.

### BACKGROUND

With the development of the new radio (NR) access technologies (i.e., 5G), a broad range of use cases including enhanced mobile broadband, massive machine-type communications (MTC), critical MTC, etc., can be realized. To expand the utilization of NR access technologies, 5G connectivity via satellites is being considered as a promising application. In contrast to the terrestrial networks where all communication nodes (e.g., base stations (BSs)) are located on the earth, a wireless communication network incorporating satellites and/or airborne vehicles to perform some or all of the functions of terrestrial base stations is referred to as a non-terrestrial network (NTN).

### SUMMARY

In NTN, as the propagation distance are significantly longer, Semi-Persistent Scheduling (SPS) can be adopted to compensate for propagation delay. SPS is configured by RRC (Radio Resource Control) and can be activated/released by DCI (Downlink Control information). In some approaches, there is no HARQ-ACK (hybrid automatic repeat request acknowledgement) feedback required after a UE (user equipment) receives the SPS PDSCH (Physical Downlink Shared Channel) activation DCI. The reason is that, in terrestrial network (TN), the confirmation of successful reception of SPS PDSCH activation DCI can be implicitly known by BS via the reception of HARQ-ACK of corresponding SPS PDSCH reception. In NTN, however, the HARQ-ACK of PDSCH may be disabled to save both signaling overhead and power due to the significant propagation delay. In this case, if the UE fails to receive the SPS PDSCH activation DCI, the following SPS PDSCH without HARQ-ACK will be out of control as well.

The present disclosure relates to methods, devices, and computer program products for wireless communication, which can allow the communication between a UE and a BS to be reliable.

One aspect of the present disclosure relates to a wireless communication method. In an embodiment, the wireless communication method includes receiving, by a wireless communication terminal from a wireless communication node, a Semi-Persistent Scheduling, SPS, activation; receiving, by the wireless communication terminal from the wireless communication node, an SPS downlink transmission corresponding to the SPS activation; and transmitting, by the wireless communication terminal to the wireless communication node, acknowledge information in response to a part of hybrid automatic repeat request, HARQ, processes for the SPS downlink transmission, based on at least one of one or more configurations or signaling.

Another aspect of the present disclosure relates to a wireless communication method. In an embodiment, the wireless communication method includes: receiving, by a wireless communication terminal from a wireless communication node, a Semi-Persistent Scheduling, SPS, activation; receiving, by the wireless communication terminal from the wireless communication node, an SPS downlink transmission corresponding to the SPS activation; and transmitting, by the wireless communication terminal to the wireless communication node, acknowledge information in response to the SPS activation.

Another aspect of the present disclosure relates to a wireless communication method. In an embodiment, the wireless communication method includes: transmitting, by a wireless communication node to a wireless communication terminal, a Semi-Persistent Scheduling, SPS, activation; transmitting, by the wireless communication terminal to the wireless communication terminal, an SPS downlink transmission corresponding to the SPS activation; and receiving, by the wireless communication node from the wireless communication terminal, acknowledge information in response to a part of hybrid automatic repeat request, HARQ, processes for the SPS downlink transmission.

Another aspect of the present disclosure relates to a wireless communication method. In an embodiment, the wireless communication method includes: transmitting, by a wireless communication node to a wireless communication terminal, a Semi-Persistent Scheduling, SPS, activation; transmitting, by the wireless communication terminal to the wireless communication terminal, an SPS downlink transmission corresponding to the SPS activation; and receiving, by the wireless communication node from the wireless communication terminal, acknowledge information in response to the SPS activation.

Various embodiments may preferably implement the following features: Preferably or in some embodiments in some embodiments, the wireless communication terminal is configured to refrain from transmitting the acknowledge information in response to another part of the HARQ processes for the SPS downlink transmission.

Preferably or in some embodiments, the wireless communication terminal is configured to transmit the acknowledge information in response to an HARQ process for the first SPS downlink transmission.

Preferably or in some embodiments, a type-1 or type-3 HARQ-acknowledgement, HARQ-ACK, codebook is configured, and the wireless communication terminal is configured to transmit the acknowledge information in the codebook in response to the part of the HARQ processes.

Preferably or in some embodiments y, a type-2 HARQ-ACK codebook is configured, and the wireless communication terminal is configured to transmit the acknowledge information in response to the part of the HARQ processes by appending the acknowledge information at the end of the codebook.

Preferably or in some embodiments, the wireless communication terminal is configured to transmit the acknowledge information in response to the part of the HARQ processes according to an HARQ process number in the SPS activation.

Preferably or in some embodiments, the wireless communication terminal is configured to transmit the acknowledge information for the part of the HARQ processes according to a predefined configuration.

Preferably or in some embodiments, the wireless communication terminal is configured to transmit the acknowledge information every N_{ack} of HARQ processes for a Transport block, TB, with N_{ack} being an integer.

Preferably or in some embodiments, the wireless communication terminal is configured to receive a value of N_{ack} from the wireless communication node in an SPS configuration.

Preferably or in some embodiments, a value of N_{ack} is determined according to a number of the HARQ processes for the TB.

Preferably or in some embodiments, a value of N_{ack} is determined according to a Physical Downlink Shared Channel, PDSCH, aggregation factor provided by the wireless communication node.

Preferably or in some embodiments, the wireless communication terminal is configured to receive an N^{th} downlink assignment of the SPS downlink transmission at a time slot determined according to the following equation:

(numberOfSlotsPerFrame×SFN+slot number in the frame)=[(numberOfSlotsPerFrame×(SFN_{start time}+SFN_{ntn time offset})+(slot_{start time}+slot_{ntn time offset})+N×periodicity×numberOfSlotsPerFrame/10]modulo(1024×numberOfSlotsPerFrame),

in which numberOfSlotsPerFrame refers to the number of consecutive slots per frame, periodicity refers to a periodicity of a configured downlink assignment for SPS, SFN_{start time} refers to a system frame number, SFN, of a firstly transmitted PDSCH in the SPS downlink transmission, slot_{start time} refers to a time slot of the firstly transmitted PDSCH in the SPS downlink transmission, SFN_{ntn time offset} refers to an offset in an NTN in SFN level, slot_{ntn time offset} refers to an offset in the NTN in time slot level, and N is an integer.

Preferably or in some embodiments, the wireless communication terminal is configured to receive a downlink assignment of the SPS downlink transmission at a time slot determined according to time offsets SFN_{ntn time offset} and slot_{ntn time offset}, and the time offsets SFN_{ntn time offset} and slot_{ntn time offset} are determined according to a round trip time RTT between the wireless communication terminal and the wireless communication node.

Preferably or in some embodiments, SFN_{ntn time offset}=floor(RTT/T_{frame}), and slot_{ntn time offset}=ceiling((RTT−SFN_{ntn time offset}*T_{frame})/Tₛₗₒₜ), wherein T_{frame} is a time length of a frame, and Tₛₗₒₜ is a time length of a slot.

Preferably or in some embodiments, the wireless communication terminal is configured to receive a downlink assignment of the SPS downlink transmission at a time slot determined according to time offsets SFN_{ntn time offset} and slot_{ntn time offset}, and the time offsets SFN_{ntn time offset} and slot_{ntn time offset} are determined according to a minimum round trip time RTT_{min per beam} of a beam corresponding to the SPS downlink transmission.

Preferably or in some embodiments, SFN_{ntn time offset}=floor(RTT_{min per beam}/T_{frame}), and slot_{ntn time offset}=ceiling((RTT_{min per beam}−SFN_{ntn time offset}*T_{frame})/Tₛₗₒₜ), wherein T_{frame} is a time length of a frame, and Tₛₗₒₜ is a time length of a slot.

Preferably or in some embodiments, the wireless communication terminal is configured to receive values of the time offsets SFN_{ntn time offset} and slot_{ntn time offset} from the wireless communication node in a PDCCH carrying the SPS activation.

Preferably or in some embodiments, the wireless communication terminal is configured to receive the minimum round-trip time RTT_{min per beam} of the beam and calculate the time offsets SFN_{ntn time offset} and slot_{ntn time offset} according to the minimum round-trip time RTT_{min per beam} of the beam.

Preferably or in some embodiments, the wireless communication terminal is configured to monitor the SPS downlink transmission no later than a time equal to SFN_{start time}+SFN_{ntn time offset}+slot_{start time}+slot_{ntn time offset}, wherein SFN_{start time} refers to a system frame number, SFN, of a firstly transmitted PDSCH in the SPS downlink transmission, slot_{start time} refers to a time slot of the firstly transmitted PDSCH in the SPS downlink transmission, SFN_{ntn time offset} refers to an offset in an NTN in SFN level, slot_{ntn time offset} refers to an offset in the NTN in time slot level.

Preferably or in some embodiments, the wireless communication terminal is configured to receive a downlink assignment of the SPS downlink transmission at a time slot determined according to time offsets SFN_{ntn time offset} and slot_{ntn time offset}, and the time offsets SFN_{ntn time offset} and slot_{ntn time offset} are determined according to a common round trip time RTT_{common per beam} between the wireless communication node and a reference point of a beam corresponding to the SPS downlink transmission.

Preferably or in some embodiments, SFN_{ntn time offset}=floor(RTT_{common per beam}/T_{frame}), and slot_{ntn time offset}=ceiling((RTT_{common per beam}−SFN_{ntn time offset}*T_{frame})/Tₛₗₒₜ), wherein T_{frame} is a time length of a frame, and Tₛₗₒₜ is a time length of a slot.

Preferably or in some embodiments, the SPS downlink transmission is transmitted by the wireless communication node no earlier than a time equal to SFN_{start time}+SFN_{ntn time offset}+slot_{start time}+slot_{ntn time offset}+SFN_{max ue offset}, wherein SFN_{start time} refers to a system frame number, SFN, of a firstly transmitted PDSCH in the SPS downlink transmission, slot_{start time} refers to a time slot of the firstly transmitted PDSCH in the SPS downlink transmission, SFN_{ntn time offset} refers to an offset in an NTN in SFN level, slot_{ntn time offset} refers to an offset in the NTN in time slot level, and SFN_{max ue offset}=ceiling(RTT_{max ue location to ref location}/T_{frame}), wherein RTT_{max ue location to ref location} is a maximum round trip time from any point in the beam to the reference point, and T_{frame} is a time length of a frame.

Preferably or in some embodiments, the wireless communication terminal is configured to monitor the SPS downlink transmission no later than a time equal to SFN_{start time}+SFN_{ntn time offset}+slot_{start time}+slot_{ntn time offset}+SFN_{ue time offset}, wherein SFN_{ue time offset}=ceiling(RTT_{ue location to ref location}/T_{frame}), wherein RTT_{ue location to ref location} is a round trip time from a location of the wireless communication terminal to the reference point.

Preferably or in some embodiments, the wireless communication node does not receive the acknowledge information in response to another part of the HARQ processes for the SPS downlink transmission.

Preferably or in some embodiments, the wireless communication node receives the acknowledge information in response to an HARQ process for the first SPS downlink transmission.

Preferably or in some embodiments, a type-1 or type-3 HARQ-acknowledgement, HARQ-ACK, codebook is configured, and the wireless communication node receives the acknowledge information in the codebook in response to the part of the HARQ processes.

Preferably or in some embodiments, a type-2 HARQ-ACK codebook is configured, and the wireless communication node receives the acknowledge information in response to the part of the HARQ processes appending the acknowledge information at the end of the codebook.

Preferably or in some embodiments, the wireless communication node transmits an HARQ process number in the SPS activation and receives the acknowledge information in response to the part of the HARQ processes corresponding to the HARQ process number.

Preferably or in some embodiments, the wireless communication node receives the acknowledge information the part of the HARQ processes according to a predefined configuration.

Preferably or in some embodiments, the wireless communication node receives the acknowledge information every N_{ack} of HARQ processes for a TB with N_{ack} being an integer.

Preferably, the wireless communication node transmits a value of N_{ack} to the wireless communication terminal in an SPS configuration.

Preferably or in some embodiments, a value of N_{ack} is determined according to a number of the HARQ processes for the TB.

Preferably or in some embodiments, a value of N_{ack} is determined according to a Physical Downlink Shared Channel, PDSCH, aggregation factor transmitted from the wireless communication node to the wireless communication terminal.

Preferably or in some embodiments, the wireless communication node transmits an N^{th} downlink assignment of the SPS downlink transmission at a time slot determined according to the following equation:

(numberOfSlotsPerFrame×SFN+slot number in the frame)=[(numberOfSlotsPerFrame×(SFN_{start time}+SFN_{ntn time offset})+(slot_{start time}+slot_{ntn time offset})+N×periodicity×numberOfSlotsPerFrame/10]modulo(1024×numberOfSlotsPerFrame),

wherein numberOfSlotsPerFrame refers to the number of consecutive slots per frame, periodicity refers to a periodicity of a configured downlink assignment for SPS, SFN_{start time} refers to a system frame number, SFN, of a firstly transmitted PDSCH in the SPS downlink transmission, slot_{start time} refers to a time slot of the firstly transmitted PDSCH in the SPS downlink transmission, SFN_{ntn time offset} refers to an offset in an NTN in SFN level, slotₙₜₙ time offset refers to an offset in the NTN in time slot level, and N is an integer.

Preferably or in some embodiments, the wireless communication node transmits a downlink assignment of the SPS downlink transmission at a time slot determined according to time offsets SFN_{ntn time offset} and slot_{ntn time offset}, and the time offsets SFN_{ntn time offset} and slot_{ntn time offset} are determined according to a round trip time RTT between the wireless communication terminal and the wireless communication node.

Preferably or in some embodiments, SFN_{ntn time offset}=floor(RTT/T_{frame}), and slot_{ntn time offset}=ceiling((RTT−SFN_{ntn time offset}*T_{frame})/Tₛₗₒₜ), T_{frame} is a time length of a frame, and Tₛₗₒₜ is a time length of a slot.

Preferably or in some embodiments, the wireless communication node transmits a downlink assignment of the SPS downlink transmission at a time slot determined according to time offsets SFN_{ntn time offset} and slot_{ntn time offset}, and the time offsets SFN_{ntn time offset} and slot_{ntn time offset} are determined according to a minimum round trip time RTT_{min per beam} of a beam corresponding to the SPS downlink transmission.

Preferably or in some embodiments, SFN_{ntn time offset}=floor(RTT_{min per beam}/T_{frame}), and slot_{ntn time offset}=ceiling((RTT_{min per beam}−SFN_{ntn time offset}*T_{frame})/Tₛₗₒₜ), T_{frame} is a time length of a frame, and Tₛₗₒₜ is a time length of a slot.

Preferably or in some embodiments, the wireless communication node transmits values of the time offsets SFN_{ntn time offset} and slot_{ntn time offset} to the wireless communication terminal in a PDCCH carrying the SPS activation.

Preferably or in some embodiments, the wireless communication node transmits the minimum round-trip time RTT_{min per beam} of the beam and calculate the time offsets SFN_{ntn time offset} and slot_{ntn time offset} according to the minimum round-trip time RTT_{min per beam} of the beam.

Preferably or in some embodiments, of the SPS downlink transmission at a time slot determined according to time offsets SFN_{ntn time offset} and slot_{ntn time offset}, and the time offsets SFN_{ntn time offset} and slot_{ntn time offset} are determined according to a common round trip time RTT_{common per beam} between the wireless communication node and a reference point of a beam corresponding to the SPS downlink transmission.

Preferably or in some embodiments, SFN_{ntn time offset}=floor(RTT_{common per beam}/T_{frame}), and slot_{ntn time offset}=ceiling((RTT_{common per beam}−SFN_{ntn time offset}*T_{frame})/Tₛₗₒₜ), wherein T_{frame} is a time length of a frame, and Tₛₗₒₜ is a time length of a slot.

Preferably or in some embodiments, the wireless communication node transmits the SPS downlink transmission no earlier than a time equal to SFN_{start time}+SFN_{ntn time offset}+slot_{start time}+slot_{ntn time offset}+SFN_{max ue offset}, wherein SFN_{start time} refers to a system frame number, SFN, of a firstly transmitted PDSCH in the SPS downlink transmission, slot_{start time} refers to a time slot of the firstly transmitted PDSCH in the SPS downlink transmission, SFN_{ntn time offset} refers to an offset in an NTN in SFN level, slot_{ntn time offset} refers to an offset in the NTN in time slot level, and SFN_{max ue offset}=ceiling(RTT_{max ue location to ref location}/T_{frame}), wherein RTT_{max ue location to ref location} is a maximum round trip time from any point in the beam to the reference point, and T_{frame} is a time length of a frame.

The present disclosure relates to a computer program product including a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows examples of codebooks according to some embodiments of the present disclosure.

FIG. 2 shows examples of codebooks according to some embodiments of the present disclosure.

FIG. 3 shows an example of a schematic diagram of a wireless communication terminal according to an embodiment of the present disclosure.

FIG. 4 shows an example of a schematic diagram of another wireless communication node according to another embodiment of the present disclosure.

FIG. 5 shows a flowchart of a wireless communication method according to an embodiment of the present disclosure.

FIG. 6 shows a flowchart of another wireless communication method according to an embodiment of the present disclosure.

FIG. 7 shows a flowchart of another wireless communication method according to an embodiment of the present disclosure.

FIG. 8 shows a flowchart of another wireless communication method according to an embodiment of the present disclosure.

### DETAILED DESCRIPTION

In embodiments of the present disclosure, a HARQ acknowledgement method in SPS downlink (DL) transmission is proposed to ensure reliable SPS DL in NTN scenarios with relatively lower signaling overhead. In the following paragraphs, two approaches are given in various embodiments. One is to enable HARQ-ACK for only part of the HARQ processes of a given SPS PDSCH configuration. The other is to enable HARQ-ACK for the SPS PDSCH activation itself.

The following parameters may be configured in RRC signaling when the SPS is configured:
cs-RNTI: CS-RNTI for activation, release, and retransmission;
nrofHARQ-Processes: the number of configured HARQ processes for SPS;
harq-ProcID-Offset: Offset of HARQ process for SPS; and
periodicity: periodicity of configured downlink assignment for SPS.
   Approach 1: SPS Transmission with HARQ-ACK Enabled

In an embodiment, a UE may check the network type to see whether it is an NTN UE (e.g., whether the UE is attached to an NTN network). The network type can be indicated in PLMN (Public Land Mobile Network) ID. For example, PLMN ID may include 3 digits of Mobile Country Code (MCC) and 2 to 3 digits of Mobile Network Code (MNC). The NTN network type can be indicated by MNC.

For an NTN UE, if the UE is configured with SPS PDSCH by RRC signaling, the UE can monitor the downlink assignment in its Physical Downlink Control Channel (PDCCH) occasion with its CS-RNTI (Configured Scheduling-Radio Network Temporary Identifier). If the NDI (New Data Indicator) in the received HARQ information is 0, and if the PDCCH content indicates SPS PDSCH activation, the UE may store the downlink assignment (e.g., time resource) and the associated HARQ information as a configured downlink assignment. The UE may initialize or re-initialize the configured downlink assignment to start in the associated PDSCH duration and the N^{th} downlink assignment to recur in the slot for which:

(numberOfSlotsPerFrame×SFN+slot number in the frame)=[(numberOfSlotsPerFrame×SFN_{start time}+slot_{start time})+N×periodicity×numberOfSlotsPerFrame/10]modulo(1024×numberOfSlotsPerFrame),

where SFN_{start time} and slot_{start time} are the System Frame Number (SFN) and slot, respectively, of the first transmission of PDSCH where the configured downlink assignment is initialized or reinitialized.

In other words, the N^{th} downlink assignment of the SPS DL transmission may be started at the time slot presented as numberOfSlotsPerFrame×SFN+slot number in the frame.

In some embodiments, the UE may only transmit the HARQ-ACK feedback for part of SPS PDSCH transmission. The UE may determine the slots or HARQ processes which need feedback according to one or more configurations and/or signaling received from the BS.

### Approach 1—Embodiment 1

In an embodiment, for configured downlink assignments without harq-ProcID-Offset, the HARQ Process ID associated with the slot where the DL transmission starts is derived from the following equation:

HARQ Process ID=[floor(CURRENT_slot×10/(numberOfSlotsPerFrame×periodicity))]modulo nrofHARQ-Processes,

where CURRENT_slot=[(SFN×numberOfSlotsPerFrame)+slot number in the frame] and numberOfSlotsPerFrame refers to the number of consecutive slots per frame.

For configured downlink assignments with harq-ProcID-Offset, the HARQ Process ID associated with the slot where the DL transmission starts is derived from the following equation:

HARQ Process ID=[floor(CURRENT_slot/periodicity)]modulo nrofHARQ-Processes+harq-ProcID-Offset,

where CURRENT_slot=[(SFN×numberOfSlotsPerFrame)+slot number in the frame] and numberOfSlotsPerFrame refers to the number of consecutive slots per frame.

In an embodiment, after the UE starts reception of the SPS PDSCH, the UE acknowledges the first HARQ process for each Transport Block (TB), in which the first HARQ process refers to the HARQ process firstly performed or execute for the corresponding TB. In this way, the BS can be informed about the successful activation of the DL SPS. Besides, the signaling overhead of HARQ-ACK is 1/nrofHARQ-Processes compared with sending HARQ-ACK for all HARQ processes of this SPS PDSCH. For each received DL TB and associated HARQ information, if this is the very first received transmission for this TB (i.e., there is no previous NDI for this TB), the UE may determine the associated HARQ process ID is the first HARQ process. The UE indicates acknowledgements for the first HARQ process for this TB during the SPS DL reception. The UE does not indicate acknowledgements for other HARQ processes for this TB during the SPS DL reception.

In some embodiments, there are 3 types of HARQ-ACK codebooks. Following method of HARQ-ACK applies to all these 3 types.

In an embodiment, if type-1 HARQ-ACK codebook is configured (i.e., the UE is configured with pdsch-HARQ-ACK-Codebook=semi-static), only part of HARQ processes (with HARQ ID equal to the first HARQ ID described above) are feedbacked in the codebook.

In an embodiment, if type-2 HARQ-ACK codebook is configured (i.e., the UE is configured with pdsch-HARQ-ACK-Codebook=dynamic or configured with pdsch-HARQ-ACK-Codebook=enhancedDynamic-r16), only HARQ-ACK information bits of part of HARQ processes are appended at the end of the codebook.

In an embodiment, if type-3 HARQ-ACK codebook is configured (i.e., the BS provides pdsch-HARQ-ACK-OneShotFeedback-r16 to a UE in its RRC configuration and the BS sends a DCI format to the UE to activate SPS PDSCH), only part of HARQ processes are feedbacked in the codebook.

### Approach 1—Embodiment 1—Option 1: SPS PDSCH Activation with Explicit HARQ Process Index with HARQ-ACK Feedback

If the UE is provided a single configuration for SPS PDSCH, the HARQ process number field (with 4 bits) in the DCI format indicates the HARQ process with HARQ-ACK enabled. All the other HARQ processes of the UE's SPS PDSCH do not feedback corresponding HARQ-ACK. That is, the UE transmits the HARQ-ACK to the BS in response to the HARQ process with the HARQ process number matches the number in the HARQ process number field, and the UE refrains from transmitting the HARQ-ACK to the BS in response to the other HARQ processes of the UE's SPS PDSCH.

### Approach 1—Embodiment 1—Option 2-1: SPS PDSCH Activation with Implicit HARQ Process Index with HARQ-ACK Feedback

If the UE is provided a single configuration for SPS PDSCH, the HARQ process number field (with 4 bits) in the DCI format are set ‘0’. A pre-defined HARQ process (e.g., with HARQ process index 0) sends HARQ-ACK feedback. All the other HARQ processes of the UE's SPS PDSCH do not feedback corresponding HARQ-ACK. That is, the UE transmits the HARQ-ACK to the BS in response to the pre-defined HARQ process and refrains from transmitting the HARQ-ACK to the BS in response to the other HARQ processes of the UE's SPS PDSCH.

### Approach 1—Embodiment 1—Option 2-2: SPS PDSCH Activation with Implicit HARQ Process Index with HARQ-ACK Feedback

If the UE is provided more than one configuration for SPS PDSCH, the HARQ process number field (with 4 bits) in the DCI format indicates an activation for a SPS PDSCH configuration with a same value as provided by SPSconfig-index. A pre-defined HARQ process (e.g., with HARQ process index 0) sends HARQ-ACK feedback. And all the other HARQ processes of the UE's SPS PDSCH do not feedback corresponding HARQ-ACK. That is, the UE transmits the HARQ-ACK to the BS in response to the pre-defined HARQ process and refrains from transmitting the HARQ-ACK to the BS in response to the other HARQ processes of the UE's SPS PDSCH.

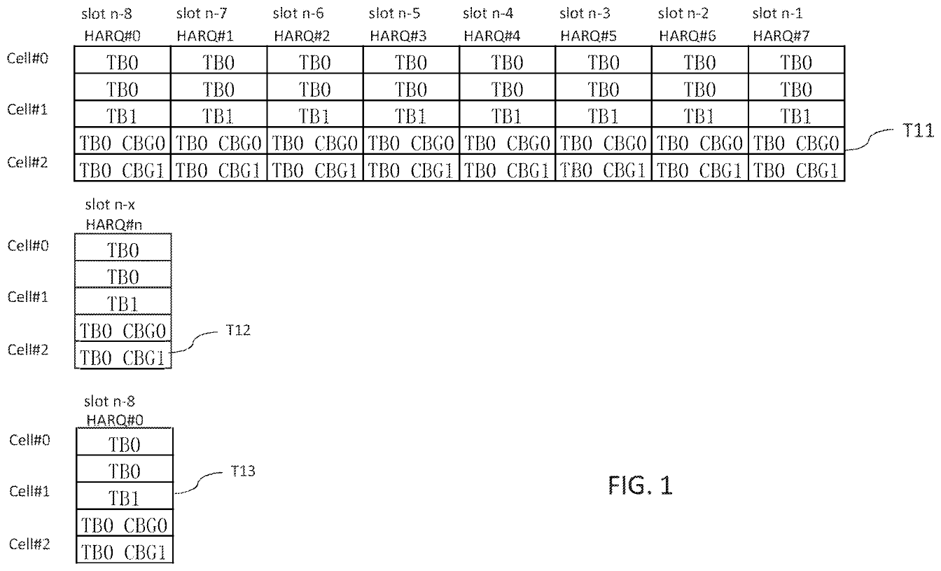

Examples of Option 1, Option 2-1, and Option 2-2 are illustrated in FIG. 1. Without loss of generality, it is assumed that the slot n-8 corresponds to HARQ #0 in this example. For type-1 codebook, the slot index is used in codebook construction. For type-3 codebook, the HARQ process index is used in codebook construction. The slot index and HARQ process index can be mapped to each other according to current NR specifications.

In this embodiment, only 1 HARQ process is feedbacked. In FIG. 1, table T11 is an example of the codebook in a comparative approach, in which all of the HARQ processes need feedback. Table T12 illustrates the codebook in Option 1, in which only the HARQ process with the first HARQ ID (i.e., n) need feedback at slot n-x, in which x is an integer. Table T13 illustrates the codebook in Option 2-1 or Option 2-2, in which only the HARQ process with the predetermined HARQ ID (i.e., 0) need feedback at slot n-8.

### Approach 1—Embodiment 2

In an embodiment, for configured downlink assignments without harq-ProcID-Offset, the HARQ Process ID associated with the slot where the DL transmission starts is derived from the following equation:

HARQ Process ID=[floor(CURRENT_slot×10/(numberOfSlotsPerFrame×periodicity))]modulo nrofHARQ-Processes,

where CURRENT_slot=[(SFN×numberOfSlotsPerFrame)+slot number in the frame] and numberOfSlotsPerFrame refers to the number of consecutive slots per frame.

For configured downlink assignments with harq-ProcID-Offset, the HARQ Process ID associated with the slot where the DL transmission starts is derived from the following equation:

HARQ Process ID=[floor(CURRENT_slot/periodicity)]modulo nrofHARQ-Processes+harq-ProcID-Offset,

where CURRENT_slot=[(SFN×numberOfSlotsPerFrame)+slot number in the frame] and numberOfSlotsPerFrame refers to the number of consecutive slots per frame.

In an embodiment, after the UE starts reception of the SPS PDSCH, the UE acknowledges every N_{ack} HARQ processes for each TB. In this way, the BS can be informed about the successful activation of the DL SPS and timely update of DL transmission quality. Besides, the signaling overhead of HARQ-ACK is 1/N_{ack} compared with HARQ-ACK for all HARQ processes.

### Approach 1—Embodiment 2—Option 1: Explicit N_{ack} in SPS PDSCH Configuration

The value of N_{ack} can be included in the SPS configuration via UE-specific RRC signaling. For example, N_{ack} can be a new field in SPS-Config with the same bitwidth of the HARQ process number field. In an embodiment, nrofHARQ-Processes modulo N_{ack}=0.

For each received DL TB and associated HARQ information, if this is the very first received transmission for this TB (i.e., there is no previous NDI for this TB), the UE considers the associated HARQ process ID HARQ-ID1 is the first HARQ process. The UE indicates acknowledgements for the HARQ processes with HARQ process ID HARQ-IDx fulfills following equation:

(HARQ-IDx−HARQ-ID1)modulo N_{ack}=0

The UE does not indicate acknowledgements for other HARQ processes for this TB during the SPS DL reception.

### Approach 1—Embodiment 2—Option 2: Implicit N_{ack} in SPS PDSCH Configuration

The value of N_{ack} can be a predefined value known by both BS and UE. For example, N_{ack}=nrofHARQ-Processes/2 can be a choice for NTN scenarios with large HARQ processes. For another example, N_{ack} can be indicated by the pdsch-AggregationFactor-r16 field (if configured) in SPS-Config or in pdsch-config, which means a HARQ-ACK will be provided for pdsch-AggregationFactor consecutive slots.

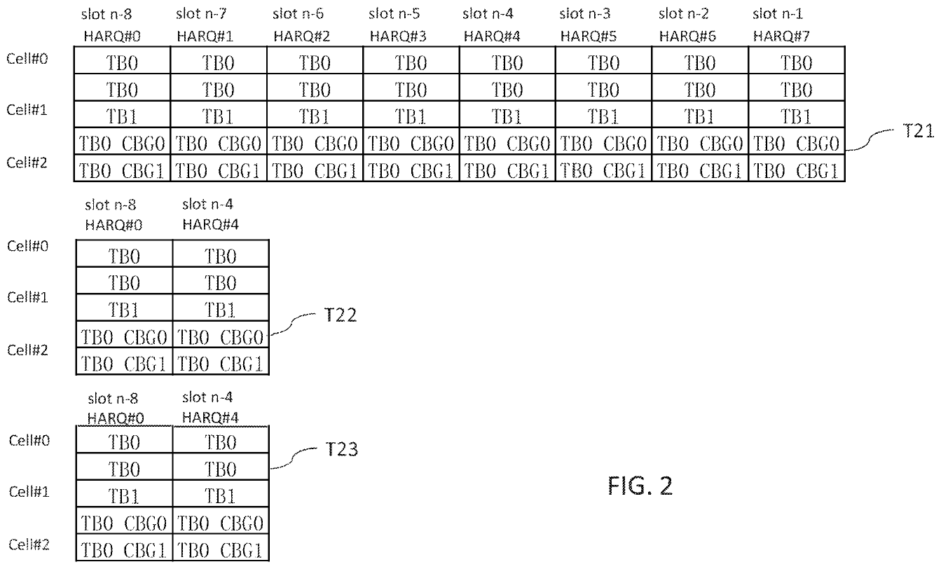

Examples of Option 1 and Option 2 are illustrated in FIG. 2. In this embodiment, nrofHARQ-Processes is 8, N_{ack} is 4, and thus, 2 HARQ processes need feedback. Without loss of generality, it is assumed that the slot n-8 corresponds to HARQ #0 in this example. For type-1 codebook, the slot index is used in codebook construction. For type-3 codebook, the HARQ process index is used in codebook construction. The slot index and HARQ process index can be mapped to each other according to current NR specifications.

In FIG. 2, table T21 is an example of the codebook in a comparative approach, in which all of the HARQ processes need feedback. Table T22 illustrates the codebook in Option 1, in which N_{ack} is configured as 4 and therefore, only the HARQ processes with the HARQ ID 0 and 4 need feedback at slots n-8 and n-4, respectively. Table T23 illustrates the codebook in Option 2, in which N_{ack} is equal to nrofHARQ-Processes/2=4, and therefore, only the HARQ processes with the HARQ ID 0 and 4 need feedback at slots n-8 and n-4, respectively.

### Approach 2—Embodiment 1: SPS Activation with HARQ-ACK

In an embodiment, a UE may check the network type to see whether it is an NTN UE (e.g., whether the UE is attached to an NTN network). The network type can be indicated in PLMN (Public Land Mobile Network) ID. For example, PLMN ID may include 3 digits of Mobile Country Code (MCC) and 2 to 3 digits of Mobile Network Code (MNC). The NTN network type can be indicated by MNC.

For an NTN UE, if the UE is configured with SPS PDSCH by RRC signaling, the UE can monitor the downlink assignment in its Physical Downlink Control Channel (PDCCH) occasion with its CS-RNTI (Configured Scheduling-Radio Network Temporary Identifier). If the NDI (New Data Indicator) in the received HARQ information is 0, and if the PDCCH content indicates SPS PDSCH activation, the UE may store the downlink assignment (e.g., time resource) and the associated HARQ information as a configured downlink assignment. The UE may indicate a positive acknowledgement for the SPS activation.

The UE may initialize or re-initialize the configured downlink assignment to start in the associated PDSCH duration and the N^{th} downlink assignment to recur in the slot for which:

(numberOfSlotsPerFrame×SFN+slot number in the frame)=[(numberOfSlotsPerFrame×(SFN_{start time}+SFN_{ntn time offset})+(slot_{start time}+slot_{ntn time offset})+N×periodicity×numberOfSlotsPerFrame/10]modulo(1024×numberOfSlotsPerFrame),

In some embodiments, SFN_{start time}, SFN_{ntn time offset}, slot_{start time} and slot_{ntn time offset} can be determined according to the methods described below.

In other words, the N^{th} downlink assignment of the SPS DL transmission may be started at the time slot presented as numberOfSlotsPerFrame×SFN+slot number in the frame.

### Approach 2—Embodiment 1—Option 1

In some embodiments, SFN_{start time} and slot_{start time} are the System Frame Number (SFN) and slot, respectively, of the first transmission of PDSCH where the configured downlink assignment is (re-)initialized without consideration of propagation delay in NTN, SFN_{ntn time offset} and slot_{ntn time offset} are the time offset on the SFN and slot level, respectively, due to propagation delay (e.g., the round trip time) in NTN scenarios.

In an example, if the location of the UE is known by the BS (e.g., reported by the UE to the BS), the value of SFN_{ntn time offset} and slot_{ntn time offset} can be calculated by the BS and indicated in the PDCCH carrying SPS activation. The calculation method is: SFN_{ntn time offset}=floor(RTT/T_{frame}) and slot_{ntn time offset}=ceiling((RTT−SFN_{ntn time offset}*T_{frame})/Tₛₗₒₜ), where T_{frame} and Tₛₗₒₜ are the time length of a frame and a slot in the same time unit of RTT, respectively, in which RTT is the round trip time between the UE and the BS.

In another example, the value of SFN_{ntn time offset} and slot_{ntn time offset} can be calculated using the minimum round-trip time (RTT_{min per beam}) of the associated beam. The calculation method is: SFN_{ntn time offset}=floor(RTT_{min per beam}/T_{frame}) and slot_{ntn time offset}=ceiling((RTT_{min per beam}−SFN_{ntn time offset}*T_{frame})/Tₛₗₒₜ), where T_{frame} and Tₛₗₒₜ are the time length of a frame and a slot in the same time unit of RTT_{min per beam}, respectively. The UE may monitor the configured SPS DL transmission no later than SFN_{start time}+SFN_{ntn time offset}+slot_{start time}+slot_{ntn time offset}.

In this example, according to an embodiment, the BS may calculate the values of SFN_{ntn time offset} and slot_{ntn time offset} and transmit them to the UE in the PDCCH carrying SPS activation. In an alternative embodiment, the BS may broadcast RTT_{min per beam} via system information. The UE may receive the broadcasted RTT_{min per beam}, and accordingly calculate the values of SFN_{ntn time offset} and slot_{ntn time offset}.

In another example, the value of SFN_{ntn time offset} and slot_{ntn time offset} can be calculated using the common round-trip time (RTT_{common per beam}) to a given reference point (e.g., a center point of the beam) of the associated beam. That is, the common round-trip time is the round-trip time between the BS and the reference point. The calculation method is: SFN_{ntn time offset}=floor(RTT_{common per beam}/T_{frame}) and slot_{ntn time offset}=ceiling((RTT_{common per beam}−SFN_{ntn time offset}*T_{frame})/Tₛₗₒₜ), where T_{frame} and Tₛₗₒₜ are the time length of a frame and a slot in the same time unit of RTT_{common per beam}, respectively.

In this example, according to an embodiment, the BS may calculate the values of SFN_{ntn time offset} and slot_{ntn time offset} and transmit them to the UE via system information or in the PDCCH carrying SPS activation. The BS may broadcast the location of the given reference point of the beam. The BS may transmit the configured SPS DL transmission no earlier than SFN_{start time}+SFN_{ntn time offset}+slot_{start time}+slot_{ntn time offset}+SFN_{max ue offset}, where SFN_{max ue offset}=ceiling(RTT_{max ue location to ref location}/T_{frame}) and RTT_{max ue location to ref location} is the maximum round trip time from any point in the beam to the given reference point of the beam. The UE may calculate SFN_{ue time offset}=ceiling(RTT_{ue location to ref location}/T_{frame}), where RTT_{ue location to ref location} is the round-trip time from the UE's location to the given reference point of the beam. The UE may monitor the configured SPS DL transmission no later than SFN_{start time}+SFN_{ntn time offset}+slot_{start time}+Slot_{ntn time offset}+SFN_{ue offset}.

According to an alternative embodiment, the BS may broadcast its location (e.g., a BS on satellite or an ATG BS on ground) and the location of the given reference point of the beam. The BS may calculate the values of SFN_{ntn time offset} and slot_{ntn time offset}. The BS may transmit the configured SPS DL transmission no earlier than SFN_{start time}+SFN_{ntn time offset}+slot_{start time}+slot_{ntn time offset}+SFN_{max ue offset}, where SFN_{max ue offset}=ceiling(RTT_{max ue location to ref location}/T_{frame}) and RTT_{max ue location to ref location} is the maximum RTT from any point in the beam to the given reference point of the beam. The UE may calculate SFN_{ue time offset}=floor(RTT_{ue location to bs location}/T_{frame}) and slot_{ue time offset}=ceiling((RTT_{ue location to bs location}−SFN_{ue time offset}*T_{frame})/Tₛₗₒₜ), where RTT_{ue location to bs location} is the round-trip time from the location of the UE to the BS location. The may UE monitor the configured SPS DL transmission no later than SFN_{start time}+SFN_{ue time offset}+slot_{start time}+slot_{ue time offset}.

In an embodiment, SFN_{ntn time offset} and slot_{ntn time offset}, which are defined to cover the propagation delay in NTN scenarios, can be optional information elements corresponding to the network type.

### Approach 2—Embodiment 1—Option 2

In some embodiments, SFN_{start time} and slot_{start time} are the System Frame Number (SFN) and slot, respectively, of the first transmission of PDSCH where the configured downlink assignment is (re-)initialized with consideration of propagation delay in NTN. For example, SFN_{start time} and slot_{start time} are the SFN and slot, respectively, of the first transmission of PDSCH where the configured downlink assignment was initialized or reinitialized include propagation delay in NTN. In such an example, SFN_{ntn time offset} and slot_{ntn time offset} can omitted.

In some embodiments, different bitwidth of SFN_{start time} and slot_{start time} can be defined for typical NTN scenarios with different round trip time range. Corresponding scenario type indication may be needed to determine the bithwidth of SFN_{start time} and slot_{start time}.

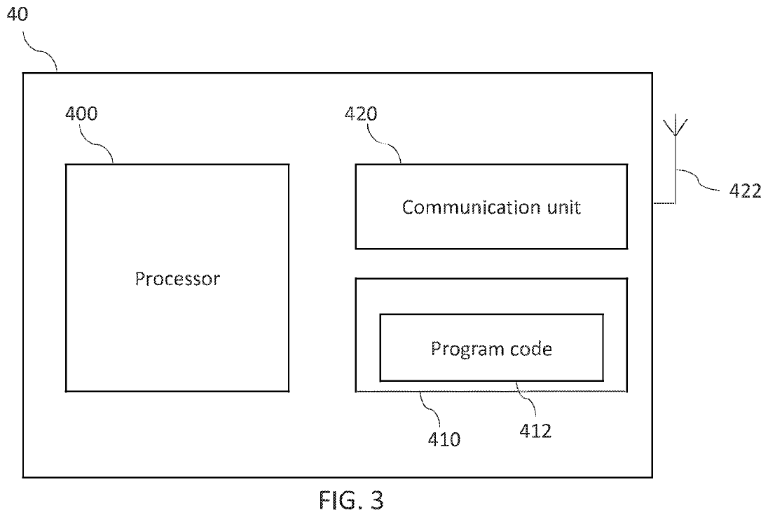

FIG. 3 relates to a schematic diagram of a wireless communication terminal 40 (e.g., a terminal node or a terminal device) according to an embodiment of the present disclosure. The wireless communication terminal 40 may be a user equipment (UE), a mobile phone, a laptop, a tablet computer, an electronic book or a portable computer system and is not limited herein. The wireless communication terminal 40 may include a processor 400 such as a microprocessor or Application Specific Integrated Circuit (ASIC), a storage unit 410 and a communication unit 420. The storage unit 410 may be any data storage device that stores a program code 412, which is accessed and executed by the processor 400. Embodiments of the storage code 412 include but are not limited to a subscriber identity module (SIM), read-only memory (ROM), flash memory, random-access memory (RAM), hard-disk, and optical data storage device. The communication unit 420 may a transceiver and is used to transmit and receive signals (E.g., messages or packets) according to processing results of the processor 400. In an embodiment, the communication unit 420 transmits and receives the signals via at least one antenna 422.

In an embodiment, the storage unit 410 and the program code 412 may be omitted and the processor 400 may include a storage unit with stored program code.

The processor 400 may implement any one of the steps in exemplified embodiments on the wireless communication terminal 40, e.g., by executing the program code 412.

The communication unit 420 may be a transceiver. The communication unit 420 may as an alternative or in addition be combining a transmitting unit and a receiving unit configured to transmit and to receive, respectively, signals to and from a wireless communication node.

In some embodiments, the wireless communication terminal 40 may be used to perform the operations of the UE described above. In some embodiments, the processor 400 and the communication unit 420 collaboratively perform the operations described above. For example, the processor 400 performs operations and transmit or receive signals, message, and/or information through the communication unit 420.

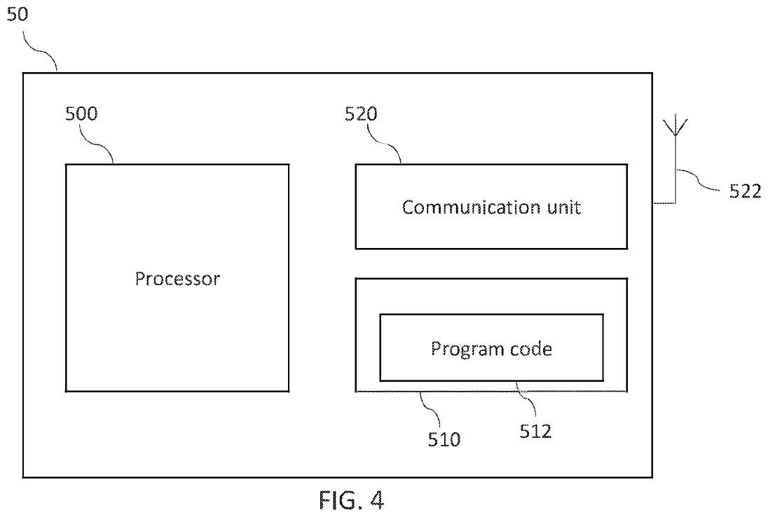

FIG. 4 relates to a schematic diagram of a wireless communication node 50 (e.g., a network device) according to an embodiment of the present disclosure. The wireless communication node 50 may be a satellite, a base station (BS) (e.g., a gNB), a network entity, a Mobility Management Entity (MME), Serving Gateway (S-GW), Packet Data Network (PDN) Gateway (P-GW), a radio access network (RAN), a next generation RAN (NG-RAN), a data network, a core network or a Radio Network Controller (RNC), and is not limited herein. In addition, the wireless communication node 50 may include (perform) at least one network function such as an access and mobility management function (AMF), a session management function (SMF), a user place function (UPF), a policy control function (PCF), an application function (AF), etc. The wireless communication node 50 may include a processor 500 such as a microprocessor or ASIC, a storage unit 510 and a communication unit 520. The storage unit 510 may be any data storage device that stores a program code 512, which is accessed and executed by the processor 500. Examples of the storage unit 512 include but are not limited to a SIM, ROM, flash memory, RAM, hard-disk, and optical data storage device. The communication unit 520 may be a transceiver and is used to transmit and receive signals (E.g., messages or packets) according to processing results of the processor 500. In an example, the communication unit 520 transmits and receives the signals via at least one antenna 522.

In an embodiment, the storage unit 510 and the program code 512 may be omitted. The processor 500 may include a storage unit with stored program code.

The processor 500 may implement any steps described in exemplified embodiments on the wireless communication node 50, e.g., via executing the program code 512.

The communication unit 520 may be a transceiver. The communication unit 520 may as an alternative or in addition be combining a transmitting unit and a receiving unit configured to transmit and to receive, respectively, signals, messages, or information to and from a wireless terminal (E.g., a user equipment).

In some embodiments, the wireless communication node 50 may be used to perform the operations of the BS described above. In some embodiments, the processor 500 and the communication unit 520 collaboratively perform the operations described above. For example, the processor 500 performs operations and transmit or receive signals through the communication unit 520.

A wireless communication method is also provided according to an embodiment of the present disclosure. In an embodiment, the wireless communication method may be performed by using a wireless communication terminal (e.g., a UE). In an embodiment, the wireless communication terminal may be implemented by using the wireless communication terminal 40 described above but is not limited thereto.

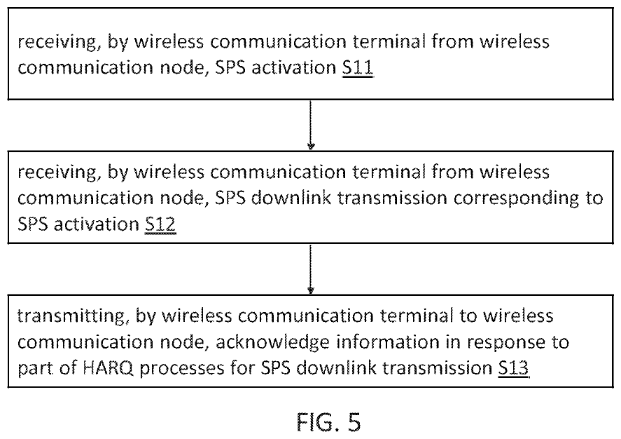

Referring to FIG. 5, in an embodiment, the wireless communication method includes receiving, by a wireless communication terminal from a wireless communication node, a Semi-Persistent Scheduling, SPS, activation (operation S11); receiving, by the wireless communication terminal from the wireless communication node, an SPS downlink transmission corresponding to the SPS activation (operation S12); and transmitting, by the wireless communication terminal to the wireless communication node, acknowledge information in response to a part of hybrid automatic repeat request, HARQ, processes for the SPS downlink transmission (operation S13). In an embodiment, the part of the HARQ processes are determined based on one or more configurations and/or signaling transmitted by the wireless communication node.

Details in this regard can be ascertained with reference to the paragraphs above and will not be repeated herein.

Another wireless communication method is also provided according to an embodiment of the present disclosure. In an embodiment, the wireless communication method may be performed by using a wireless communication terminal (e.g., a UE). In an embodiment, the wireless communication terminal may be implemented by using the wireless communication terminal 40 described above but is not limited thereto.

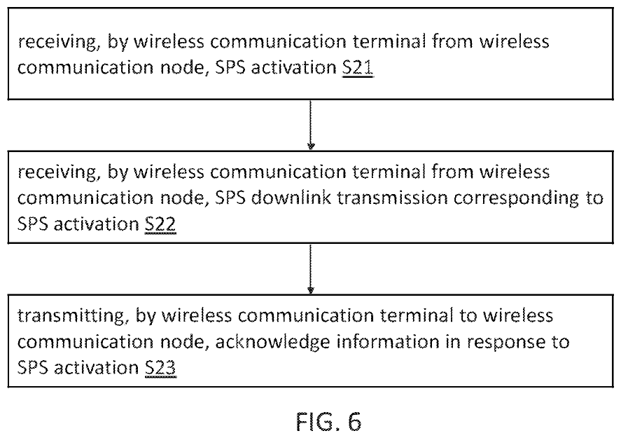

Referring to FIG. 6, in an embodiment, the wireless communication method includes receiving, by a wireless communication terminal from a wireless communication node, a Semi-Persistent Scheduling, SPS, activation (operation S21); receiving, by the wireless communication terminal from the wireless communication node, an SPS downlink transmission corresponding to the SPS activation (operation S22); and transmitting, by the wireless communication terminal to the wireless communication node, acknowledge information in response to the SPS activation (operation S23).

In an embodiment, the wireless communication terminal is configured to transmit the acknowledge information in response to an HARQ process for the first SPS downlink transmission. In an embodiment, the first SPS downlink transmission is a SPS downlink transmission firstly performed for each TB.

Details in this regard can be ascertained with reference to the paragraphs above and will not be repeated herein.

Another wireless communication method is also provided according to an embodiment of the present disclosure. In an embodiment, the wireless communication method may be performed by using a wireless communication node (e.g., a BS). In an embodiment, the wireless communication node may be implemented by using the wireless communication node 50 described above but is not limited thereto.

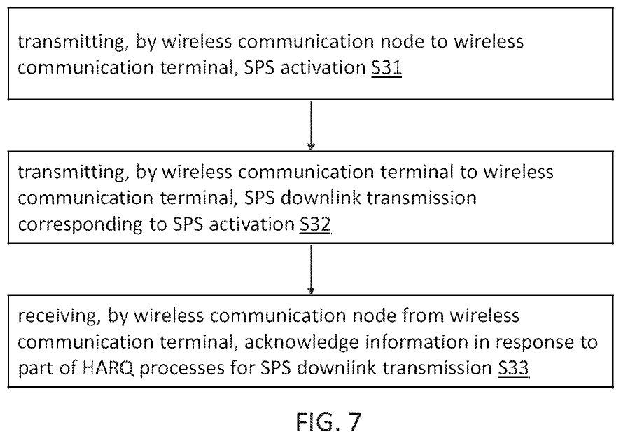

Referring to FIG. 7, in an embodiment, the wireless communication method includes transmitting, by a wireless communication node to a wireless communication terminal, a Semi-Persistent Scheduling, SPS, activation (operation S31); transmitting, by the wireless communication terminal to the wireless communication terminal, an SPS downlink transmission corresponding to the SPS activation (operation S32); and receiving, by the wireless communication node from the wireless communication terminal, acknowledge information in response to a part of hybrid automatic repeat request, HARQ, processes for the SPS downlink transmission (operation S33).

Details in this regard can be ascertained with reference to the paragraphs above and will not be repeated herein.

Another wireless communication method is also provided according to an embodiment of the present disclosure. In an embodiment, the wireless communication method may be performed by using a wireless communication node (e.g., a BS). In an embodiment, the wireless communication node may be implemented by using the wireless communication node 50 described above but is not limited thereto.

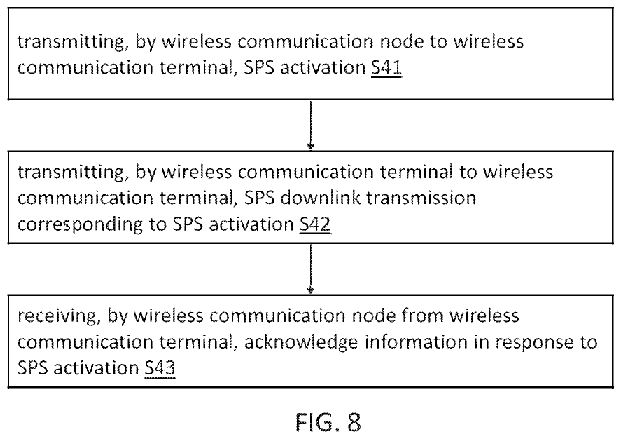

Referring to FIG. 8, in an embodiment, the wireless communication method includes transmitting, by a wireless communication node to a wireless communication terminal, a Semi-Persistent Scheduling, SPS, activation (operation S41); transmitting, by the wireless communication terminal to the wireless communication terminal, an SPS downlink transmission corresponding to the SPS activation (operation S42); and receiving, by the wireless communication node from the wireless communication terminal, acknowledge information in response to the SPS activation (operation S43).

Details in this regard can be ascertained with reference to the paragraphs above and will not be repeated herein.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general-purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein but is to be accorded the widest scope consistent with the novel features and principles disclosed herein, as recited in the claims below.

1. A wireless communication method comprising:
receiving, by a wireless communication terminal from a wireless communication node, a Semi-Persistent Scheduling (SPS) activation;
receiving, by the wireless communication terminal from the wireless communication node, an SPS downlink transmission corresponding to the SPS activation; and
transmitting, by the wireless communication terminal to the wireless communication node, acknowledge information in response to a part of hybrid automatic repeat request (HARQ) processes for the SPS downlink transmission, based on at least one of one or more configurations or signaling.

2. The wireless communication method of claim 1, wherein the wireless communication terminal is configured to refrain from transmitting the acknowledge information in response to another part of the HARQ processes for the SPS downlink transmission.

3. The wireless communication method of claim 1, wherein the wireless communication terminal is configured to transmit the acknowledge information in response to an HARQ process for a first SPS downlink transmission.

4. The wireless communication method of claim 1, wherein the wireless communication terminal is configured to transmit the acknowledge information in response to the part of the HARQ processes according to an HARQ process number in the SPS activation.

5. The wireless communication method of claim 1, wherein the wireless communication terminal is configured to transmit the acknowledge information for the part of the HARQ processes according to a predefined configuration.

6. The wireless communication method of claim 1, wherein the wireless communication terminal is configured to transmit the acknowledge information every N_{ack} of HARQ processes for a Transport block (TB) with N_{ack} being an integer.

7. The wireless communication method of claim 6, wherein the wireless communication terminal is configured to receive a value of N_{ack} from the wireless communication node in an SPS configuration.

8. The wireless communication method of claim 6, wherein a value of N_{ack} is determined according to a number of the HARQ processes for the TB.

9. The wireless communication method of claim 6, wherein a value of N_{ack} is determined according to a Physical Downlink Shared Channel (PDSCH) aggregation factor provided by the wireless communication node.

10. A wireless communication method comprising:
transmitting, by a wireless communication node to a wireless communication terminal, a Semi-Persistent Scheduling (SPS) activation;
transmitting, by the wireless communication terminal to the wireless communication terminal, an SPS downlink transmission corresponding to the SPS activation; and
receiving, by the wireless communication node from the wireless communication terminal, acknowledge information in response to a part of hybrid automatic repeat request (HARQ) processes for the SPS downlink transmission.

11. The wireless communication method of claim 10, wherein the wireless communication node does not receive the acknowledge information in response to another part of the HARQ processes for the SPS downlink transmission.

12. The wireless communication method of claim 10, wherein the wireless communication node receives the acknowledge information in response to an HARQ process for a first SPS downlink transmission.

13. The wireless communication method of claim 10, wherein the wireless communication node transmits an HARQ process number in the SPS activation and receives the acknowledge information in response to the part of the HARQ processes corresponding to the HARQ process number.

14. The wireless communication method of claim 10, wherein the wireless communication node receives the acknowledge information the part of the HARQ processes according to a predefined configuration.

15. The wireless communication method of claim 10, wherein the wireless communication node receives the acknowledge information every N_{ack} of HARQ processes for a Transport block (TB) with N_{ack} being an integer.

16. The wireless communication method of claim 15, wherein the wireless communication node transmits a value of N_{ack} to the wireless communication terminal in an SPS configuration.

17. The wireless communication method of claim 15, wherein a value of N_{ack} is determined according to a number of the HARQ processes for the TB.

18. The wireless communication method of claim 15, wherein a value of N_{ack} is determined according to a Physical Downlink Shared Channel (PDSCH) aggregation factor transmitted from the wireless communication node to the wireless communication terminal.

19. A wireless communication terminal comprising:
a communication unit configured to communicate with a wireless communication node; and
a processor configured to:
receive a Semi-Persistent Scheduling (SPS) activation from a wireless communication node;
receive an SPS downlink transmission corresponding to the SPS activation from the wireless communication node; and
transmit acknowledge information in response to a part of hybrid automatic repeat request (HARQ) processes for the SPS downlink transmission to the wireless communication node.

20. The wireless communication terminal of claim 19, wherein the wireless communication terminal is configured to refrain from transmitting the acknowledge information in response to another part of the HARQ processes for the SPS downlink transmission.
